(19) United States
(12) Patent Application Publication
(10) Pub. No.: US 2014/0329117 A1
(43) Pub. Date: Nov. 6, 2014

(54) NON-AQUEOUS ELECTROLYTE WOUND TYPE SECONDARY BATTERY

(71) Applicant: Hitachi, Ltd., Tokyo (JP)

(72) Inventors: Osamu Kubota, Tokyo (JP); Akihide Tanaka, Tokyo (JP); Masahiro Yonemoto, Tokyo (JP); Hironori Sasaki, Tokyo (JP)

(73) Assignee: HITACHI, LTD., Tokyo (JP)

(21) Appl. No.: 14/360,247

(22) PCT Filed: Oct. 31, 2012
(86) PCT No.: PCT/JP2012/078094

§ 371 Date: May 22, 2014

(30) Foreign Application Priority Data
Nov. 24, 2011 (JP) 2011-255705

(51) Int. Cl. H01M 10/0587; H01M 10/0525

(52) U.S. Cl. CPC H01M 10/0587; H01M 10/0525
USPC 429/66

(57) ABSTRACT

A method of simultaneously preventing expansion of a battery can and distortion of an electrode winding body is disclosed. A non-aqueous electrolyte wound type secondary battery includes an electrode winding body including a positive electrode sheet, a negative electrode sheet and a separator between the positive electrode sheet and the negative electrode sheet, a support member which is inside the electrode winding body and around which the electrode winding body is wound, and a battery can which contains the electrode winding body and the support member. The positive electrode sheet includes a positive electrode layer and a positive electrode lead part. The negative electrode sheet includes a negative electrode layer and a negative electrode lead part. An inside of a corner of the electrode winding body is supported by the support member. A gap is provided inside the lead part of the electrode winding body and inside the support member.

### TECHNICAL FIELD

The present invention relates to a non-aqueous electrolyte wound type secondary battery.

### BACKGROUND ART

A lithium ion secondary battery (hereinafter referred to as a lithium ion battery) using occlusion/release of lithium ions as charge and discharge reaction is greatly expected as a battery which can be applied to various usages such as a power source for a portable electronic equipment such as a cellular phone or a notebook computer, an auxiliary power source at the time of disaster, or a power source for a moving body such as an automobile or a two-wheel vehicle, because energy density larger than a related art lead battery or nickel-cadmium battery can be obtained, lithium contributing to the charge and discharge reaction is hardly deposited as metal lithium on an electrode, the reproducibility of capacity at the time when charge and discharge are repeated is excellent, and stable charge and discharge characteristics can be obtained.

It is known that an electrode active material layer (electrode layer) containing positive electrode and negative electrode active materials of the lithium ion battery expands and contracts.

The electrode layer expands and contracts mainly because of following reasons (1) to (3). That is, (1) expansion due to lithium ion insertion into the active material and contraction due to lithium ion desorption from the active material, (2) expansion due to electrolyte holding by a binder contained in the electrode layer and contraction due to electrolyte release, and (3) expansion and contraction due to temperature change.

The above (1) repeatedly occurs at each time of charge and discharge. Although the magnitude of the expansion and contraction due to (1) varies according to the content of active material in the active material layer, the state of pores, charge depth and the like, the magnitude is of an order of 10⁺¹ [%] to 10⁺²[%] according to our experience. For example, when the negative electrode active material is graphite, the diameter changes by a maximum of about 10[%] due to the expansion and contraction, and when the negative electrode active material is a Sn-based alloy, the diameter changes by a maximum of about 400[%].

The above (2) occurs substantially only once in an electrolyte injection process at the time of battery manufacture. Although the magnitude of the expansion and contraction due to (2) changes according to the composition of the binder, the state of the pores in the electrode layer and the like, the magnitude is of an order to 10⁻¹[%] to 10⁰[%] according to our experience.

The above (3) repeatedly occurs at each time of temperature change. For example, the thermal expansion coefficient of graphite as the negative electrode active material is about 5×10^{-6 [}1/K], the thermal expansion coefficient of polyvinylidene fluoride (PVDF) as the binder is about 0.2×10^{-6 [}1/K], and the temperature difference in the battery use environment is about 10⁺² [° C.](−30 [° C.] to 60 [° C.]), and consequently, the magnitude of the expansion and contraction due to (3) is of an order of 10⁻³ to 10⁻⁵.

These orders suggest that the expansion and contraction of the electrode layer is substantially controlled by (1) and (2).

Here, the expansion and contraction due to the insertion/desorption of the lithium ion in the active material is due to the battery reaction, and the expansion due to the electrolyte holding of the binder assists the formation of the electrolyte network through which the lithium ion is conducted. Thus, to suppress the expansion and contraction of the electrode layer results in restricting the insertion/desorption and conduction of the lithium ion, and there is a possibility that the charge and discharge characteristic of the battery is deteriorated. Besides, since a load is applied to a current collection lead part at the time expansion, there is a possibility that the current collection lead part is broken. Thus, it is an important problem how to facilitate the expansion and contraction of the electrode layer.

As a method of facilitating the expansion and contraction of the electrode layer, for example, Patent Literature 1 proposes a method in which an electrode layer is formed by mixing a rubber elastic member, and the expansion and contraction of an active material simple substance is absorbed by the rubber elastic member so that the expansion and contraction of the electrode layer is facilitated.

Besides, as a method of reducing the load of a current collection lead part, for example, Patent Literature 2 proposes a method of providing the current collection lead part with slack. Although this method is proposed in order to reduce the load applied to the lead part when an electrode winding body is moved by vibration or the like, this structure could be easily applied to the method of reducing the load of the lead part when the electrode winding body is moved by the expansion and contraction.

However, when the expansion and contraction of the electrode layer is facilitated, a phenomenon occurs in which a battery can covering that is deformed by the expansion and contraction of the electrode winding body. The deformation of the battery can is remarkable especially in a square battery having such a shape as to easily receive the pressure deformation as compared with a cylindrical battery. The solving method of the problem (to facilitate the expansion and contraction of the electrode layer) would vary according to whether or not the deformation of the battery can is allowed.

As a solving method for the case where the deformation of a battery can is allowed, Patent Literature 3 proposes a secondary battery in which non-deformation pressure resistant strength of a wall surface of a battery can facing an electrode winding body is made smaller than that of a wall surface not facing the electrode winding body.

As a solving method for the case where the deformation of a battery can is not allowed, Patent Literature 4 proposes a manufacturing method of a secondary battery in which an electrode winding body is loaded in a battery can having a surplus space corresponding to the expanded volume of an electrode winding body, and charging is performed under a state where the deformation of the battery can due to the expansion of the electrode winding body is regulated.

However, in these methods, there is a possibility that the electrode winding body is distorted by repeating the charge and discharge. When the electrode winding body is distorted, the battery reaction becomes irregular, and the life characteristic of the battery is deteriorated. Thus, when the problem of facilitating the expansion and contraction of the electrode layer is solved, the problem of preventing the distortion of the electrode winding body is required to be solved at the same time.

In order to prevent the distortion of the electrode winding body, Patent Literature 5 proposes a manufacturing method of a secondary battery including a step in which a cylindrical spiral electrode winding body is formed by integrally winding a positive electrode, a separator and a negative electrode by using a core member, a step in which, while the electrode winding body is deformed into a substantially elliptical sectional shape by pressing the electrode winding body in a direction perpendicular to a winding axis after the core member is removed, the deformed electrode winding body is rotated in the same direction as a winding direction to loosen a winding state, and a step in which the electrode winding body is pressed into a flat spiral electrode winding body.

In this method, although it is expected to absorb the distortion of a corner part of the electrode winding body, it can not be expected to absorb the distortion of the electrode winding body in a long side part. This is because, in general, after the winding core is pulled out, a gap exists in the long side part of the flat electrode winding body, and therefore, when the electrode layer near the long side part expands, the expansion portion moves toward the gap, and the deformation such as buckling occurs.

In order to prevent distortion in a long side part of an electrode winding body, Patent Literature 6 proposes a secondary battery in which a plate-like core member is provided at the center of the electrode winding body.

In this method, it is expected to suppress the distortion in the long side part of the electrode winding body. However, at the time of expansion of the electrode winding body, since the electrode winding body expands toward the battery can side, it is not expected to suppress the expansion of the battery can.

### CITATION LIST

### Patent Literature

PTL 1: JP-A-9-306499
PTL 2: Japanese Patent No. 3470470
PTL 3: Japanese Patent No. 4745589
PTL 4: JP-A-2009-104902
PTL 5: JP-A-2006-164956
PTL 6: JP-A-2008-047304

### SUMMARY OF INVENTION

### Technical Problem

When the above patent literatures are summarized, in the square battery, if the method of providing the surplus space in the inside of the electrode winding body to absorb the expansion of the electrode winding body is used in order to suppress the expansion of the battery can, the distortion of the electrode winding body becomes problematic, and on the other hand, if the method of removing the surplus space is used in order to suppress the distortion of the electrode winding body, the expansion of the electrode can becomes problematic.

That is, in the above patent literatures, there is only such a method that if the expansion of the battery can is suppressed, the distortion of the electrode winding body is allowed, and if the distortion of the electrode winding body is suppressed, the expansion of the battery can is allowed. However, if a method is conceivable in which the suppression of the expansion of the battery can and the suppression of the distortion of the electrode winding body can be simultaneously realized, the method is very useful.

Accordingly, the invention proposes a method of simultaneously preventing the expansion of the battery can and the distortion of the electrode winding body.

### Solution to Problem

Features of the invention are, for example, as follows:

(1) A non-aqueous electrolyte wound type secondary battery includes an electrode winding body including a positive electrode sheet, a negative electrode sheet and a separator formed between the positive electrode sheet and the negative electrode sheet, a support member which is formed inside the electrode winding body and around which the electrode winding body is wound, and a battery can which contains the electrode winding body and the support member, the positive electrode sheet includes a positive electrode layer and a positive electrode lead part, the negative electrode sheet includes a negative electrode layer and a negative electrode lead part, an inside of a corner part of the electrode winding body is supported by the support member, and a gap is provided inside the lead part of the electrode winding body and inside the support member.

(2) In the above non-aqueous electrolyte wound type secondary battery, the support member has a rectangular tubular shape.

(3) In the above non-aqueous electrolyte wound type secondary battery, a section of the support member has a dumbbell shape.

(4) In the above non-aqueous electrolyte wound type secondary battery, a side of the support member in a winding axis direction of the electrode winding body contacts an electrode facing part of the electrode winding body, and a side of the support member in a direction perpendicular to the winding axis direction of the electrode winding body does not contact the electrode facing part of the electrode winding body.

(5) In the above non-aqueous electrolyte wound type secondary battery, the non-aqueous electrolyte wound type secondary battery includes a positive electrode current collecting terminal and a negative electrode current collecting terminal, the positive electrode current collecting terminal and the negative electrode current collecting terminal are provided with convex parts, and the convex part of the positive electrode current collecting terminal and the convex part of the negative electrode current collecting terminal hold the support member.

(6) In the above non-aqueous electrolyte wound type secondary battery, the positive electrode lead part or the negative electrode lead part includes a bent part in the lead part of the electrode winding body.

(7) In the above non-aqueous electrolyte wound type secondary battery, the bent part is formed between a side of the support member in the direction perpendicular to the winding axis direction of the electrode winding body and the electrode facing part of the electrode winding body.

(8) In the above non-aqueous electrolyte wound type secondary battery, the bent part is not formed only in the positive electrode lead part or the negative electrode lead part at an outermost periphery in the electrode winding body.

(9) In the above non-aqueous electrolyte wound type secondary battery, a shape of the battery can is square.

### Advantageous Effects of Invention

According to the invention, expansion of the battery can and distortion of the electrode winding body can be simultaneously prevented. Problems, structures and effects other than the above are clarified by the following description.

### BRIEF DESCRIPTION OF DRAWINGS

FIG. 1 is a sectional view of a square battery including a general flat spiral electrode winding body.

FIG. 2 is a view showing a structure of an electrode sheet of the embodiment.

FIG. 3 is a view showing a manufacturing method of an electrode winding body of the embodiment.

FIG. 4 is a view showing a structure of a winding unit of the embodiment.

FIG. 5 is a schematic perspective view showing an inner structure of the electrode winding body of the embodiment.

FIG. 6 is a sectional view showing the inner structure of the electrode winding body of the embodiment.

FIG. 7 is a view showing a structure of a current collecting terminal part of the embodiment.

FIG. 8 is a view showing an integrating method of the electrode winding body and the current collecting terminal part of the embodiment.

### DESCRIPTION OF EMBODIMENTS

Hereinafter, although the best mode for carrying out the invention will be described using a specific embodiment, the invention is not limited to this. Besides, the drawings in the embodiment are schematic views, and positional relations, sizes and the like in the drawings are not ensured to be accurate. Various modifications and corrections can be made by one of ordinary skill in the art within the scope of technical concept disclosed in the specification. Besides, in all the drawings for explaining the invention, components having the same function are denoted by the same reference numeral and a duplicate description thereof is sometimes omitted.

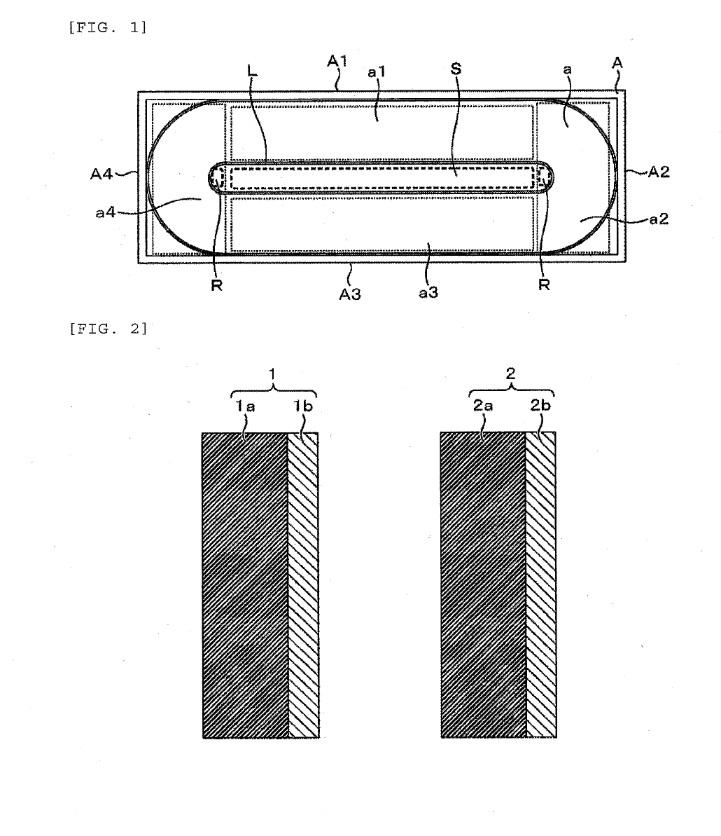

Names of parts of an electrode winding body set forth in the specification will be summarized below. FIG. 1 is a sectional view showing an inner structure of a square battery including a general flat spiral electrode winding body. “A” denotes a wall surface of a can of the square battery, and “a” denotes the electrode winding body. A wide width surface A1 of the can of the square battery, a narrow width surface A2 of the can of the square battery, a wide width surface A3 of the can of the square battery, and a narrow width surface A4 of the can of the square battery are included in the wall surface A of the can of the square battery. An area a1 of the electrode winding body facing the wide width surface A1 of the can of the square battery, an area a2 of the electrode winding body facing the narrow width surface A2 of the can of the square battery, an area a3 of the electrode winding body facing the wide width surface A3 of the can of the square battery, an area a4 of the electrode winding body facing the narrow width surface A4 of the can of the square battery, and a line L indicating a substantially inner wall in a section of the electrode winding body “a” are included in the electrode winding body “a”.

In the specification, with respect to the parts of the electrode winding body “a”, an area surrounded by the line L indicating the substantially inner wall in the section of the electrode winding body “a” of FIG. 1 is represented as the inside of the electrode winding body “a”. The area a1 of the electrode winding body facing the wide width surface A1 of the can of the square battery, and the area a3 of the electrode winding body facing the wide width surface A3 of the can of the square battery, which face the wide width surface A1 of the can of the square battery and the wide width surface A3 of the can of the square battery, are represented as long side parts of the electrode winding body “a”. The area a2 of the electrode winding body “a” and the area a4 of the electrode winding body “a”, which face the narrow width surface A2 of the can of the square battery and the narrow width surface A4 of the can of the square battery, are represented as corner parts. Besides, an inside area S of the electrode winding body “a” is represented as an inside of the long side part, and an area R is represented as an inside of the corner part.

### Embodiment 1

### Fabrication of Electrode Sheet

A positive electrode slurry was obtained in such a way that LiNi_{0.33}Mn_{0.33}Co_{0.33}O₂ as a positive electrode active material, powder carbon as a conductive agent, polyvinylidene fluoride (PVDF) as a binding agent were measured at a weight ratio of positive electrode active material:conductive agent:binding agent=85:10:5, a suitable amount of N-methyl-pyrrolidone (NMP) as a dispersing solvent was added thereto, and then, these were kneaded for 30 minutes by a kneading machine. This positive electrode slurry was coated on an aluminum current collecting sheet (thickness 20 μm width 200 mm), and after drying at 120° C., roll-pressing was performed at a load of 0.5 t/cm, so that a positive electrode sheet 1 shown in FIG. 2 was obtained. At this time, a non-coated part remains in a longitudinal direction of the positive electrode sheet 1. The positive electrode sheet 1 includes a positive electrode layer la and a positive electrode lead part 1b. The coated part of the positive electrode sheet 1 becomes the positive electrode layer 1a, and the non-coated part of the positive electrode sheet 1 becomes the positive electrode lead part 1b described later.

Here, as the positive electrode active material of the invention, in addition to LiMn composite oxide, LiCo composite oxide and LiNi composite oxide, any well-known positive electrode active materials of laminar bodies, solid solutions or the like can be used.

A negative electrode slurry was obtained in such a way that natural graphite as a negative electrode active material, powder carbon as a conductive agent, and PVDF as a binding agent were measured at a weight ratio of negative electrode active material:conductive agent:binding agent=90:5:5, a suitable amount of NMP as a dispersing solvent was added thereto, and then, these were kneaded for 30 minutes by a kneading machine. The obtained negative electrode slurry was coated on a copper current collecting sheet (thickness 10 μm, width 200 mm), and after drying at 120° C., roll-pressing was performed at a load of 0.5 t/cm, so that a negative electrode sheet 2 shown in FIG. 2 was obtained. At this time, a non-coated part remains in a longitudinal direction of the negative electrode sheet 2. The negative electrode sheet 2 includes a negative electrode layer 2a and a negative electrode lead part 2b. The coated part of the negative electrode sheet 2 becomes the negative electrode layer 2a, and the not-coated part of the negative electrode sheet 2 becomes the negative electrode lead part 2b described later.

Here, as the negative electrode active material of the invention, in addition to various graphites including natural graphite and artificial graphite, any well-known negative electrode active materials including Si oxide, LiTi composite oxide and Sn alloy can be used. As the binding agent of the invention, PVDF, styrene-butadiene rubber (SBR) or the like can be used.

### <Fabrication of Electrode Winding Body>

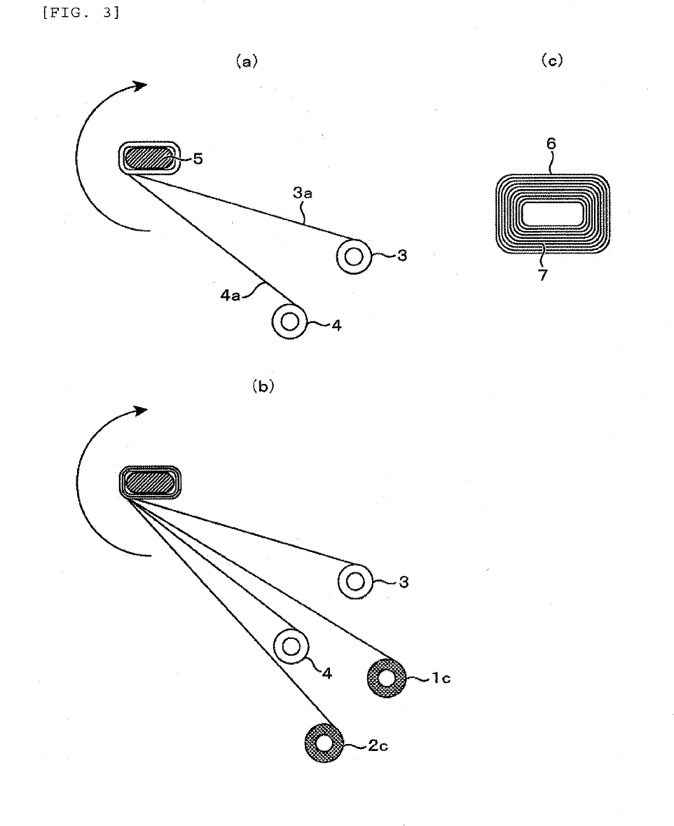

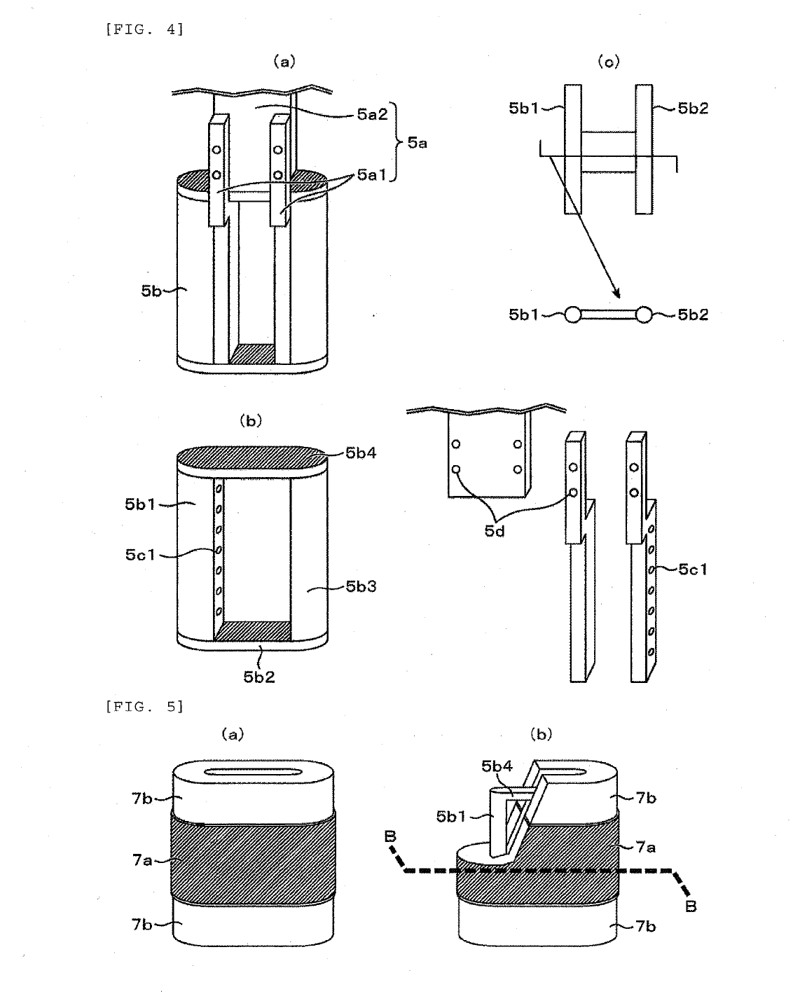

Next, a fabrication method of the electrode winding body of the embodiment will be described with reference to FIG. 3. First, as shown in FIG. 3A, a first separator 3a and a second separator 4a are respectively drawn from separator rolls 3 and 4 constructed by winding band-like separators, leading edges thereof are attached to a substantially plate-like winding unit 5, and the winding unit 5 is rotated in an arrow direction, so that the first separator 3a and the second separator 4a are wound around the winding unit 5. The winding unit 5 can be rotated around the center line thereof. Incidentally, the details of the winding unit 5 will be described later.

Here, as the separator of the invention, a polypropylene (PP) separator, a polyethylene (PE) separator, or a cellulose separator can be used. Besides, from the viewpoint of suppressing battery heat generation due to overcharging or the like, for example, an integrated separator of the PP separator and the PE separator, or an integrated separator in which a ceramic layer is coated on the surface of the PP separator can be used.

Next, as shown in FIG. 3B, a positive electrode sheet 1 and a negative electrode sheet 2 are respectively drawn from a positive electrode roll 1c constructed by winding the positive electrode sheet 1 and a negative electrode roll 2c constructed by winding the negative electrode sheet 2, and leading edges thereof are attached to the winding unit 5 around which the separators are already wound. In this case, the leading edges of the electrode sheets are attached to the winding unit 5 so that one of the positive electrode sheet 1 and the negative electrode sheet 2 is positioned between the first separator 3a and the second separator 4a, and the other of the positive electrode sheet 1 and the negative electrode sheet 2 is positioned on the outer surface side of the first separator 3a. At this time, the electrode layers as the coated parts of the positive electrode sheet 1 and the negative electrode sheet 2 are made to face each other while the separator is sandwiched therebetween. The lead parts as the electrode non-coated parts of both the electrode sheets are not made to face each other.

Next, the winding unit 5 is rotated, and winding is performed a desired number of times. In the winding, the positive electrode sheet 1, the negative electrode sheet 2 and the separators contact each other only by overlapping, and are not connected by an adhesive or the like.

When the winding is completed, the positive electrode sheet 1, the negative electrode sheet 2 and the separators are cut from those rolls. The cut ends are fixed to the side surface of the electrode winding body by an adhesive tape 6. Finally, an axial core as a part of the winding unit 5 is drawn out from the center of the electrode winding body, so that an electrode winding body 7 shown in FIG. 3C is obtained. The electrode winding body 7 includes the positive electrode sheet 1, the negative electrode sheet 2, the first separator 3a and the second separator 4a.

FIG. 4A shows a structure of the winding unit 5. The winding unit 5 includes an axial core 5a and a support member 5b. The axial core of the winding unit 5 has a comb shape in which two insertion parts 5a2 are fastened to a plate part Sal of the axial core 5a by bolts. The winding unit 5 can be decomposed into the plate part 5a1 of the axial core 5a, the insertion part 5a2 of the axial core 5a, and the support member 5b as shown in FIG. 4B by removing the bolts (not shown) of a fastening part 5d. Incidentally, the support member 5b includes a concave part 5c1, the axial core 5a includes a convex part 5c2, and the concave and convex parts are contacted with each other so that the support member 5b and the axial core 5a successfully constitute the winding unit 5.

The support member 5b is electrically insulative and has a substantially rectangular tubular shape. The support member 5b is made to have the substantially rectangular tubular shape, so that clearance of the electrode winding body 7 can be made large. The support member 5b is separated from the axial core 5a at the last of the fabrication process of the electrode winding body 7, and is held inside the electrode winding body 7 while supporting the inside of the corner of the electrode winding body 7. The support member 5b includes a side 5b1 of the support member 5b, a side 5b2 of the support member 5b, a side 5b3 of the support member 5b, and a side 5b4 of the support member 5b. The side 5b1 of the support member 5b and the side 5b3 of the support member 5b are sides in the winding axis direction of the electrode winding body 7. The side 5b2 of the support member 5b and the side 5b4 of the support member 5b are sides substantially perpendicular to the winding axis direction of the electrode winding body 7.

The arrangement of the respective sides in an assembled state in the electrode winding body 7 is as follows. The side 5b1 of the support member 5b and the side 5b3 of the support member 5b are arranged to cross the inside electrode facing part of the electrode winding body 7, and most thereof contact the inside electrode facing part of the electrode winding body 7. On the other hand, the side 5b2 of the support member 5b and the side 5b4 of the support member 5b are located outside the inside electrode facing part of the electrode winding body 7, and do not contact the inside electrode facing part of the electrode winding body 7. An area surrounded by the side 5b1 of the support member 5b, the side 5b2 of the support member 5b, the side 5b3 of the support member 5b and the side 5b4 of the support member 5b is a gap, and the area receives the expansion of the electrode winding body 7.

Incidentally, when the existing object of the area surrounded by the four sides is considered, the entire area surrounded by the four sides is not necessarily required to be the gap. For example, the support member having dumbbell-shaped section shown in FIG. 4C can be used. When the electrode winding body 7 is contracted, the side 5b1 of the support member 5b and the side 5b3 of the support member 5b receive a force directed to the inside of the electrode winding body 7. If the positions of the side 5b1 of the support member 5b and the side 5b2 of the support member 5b are shifted to the inside of the electrode winding body 7 by this force, fraying of the corner part can not be prevented. When the section of the support member 5b is dumbbell-shaped, the shift of the side 5b1 of the support member 5b and the side 5b2 of the support member 5b to the inside can be prevented.

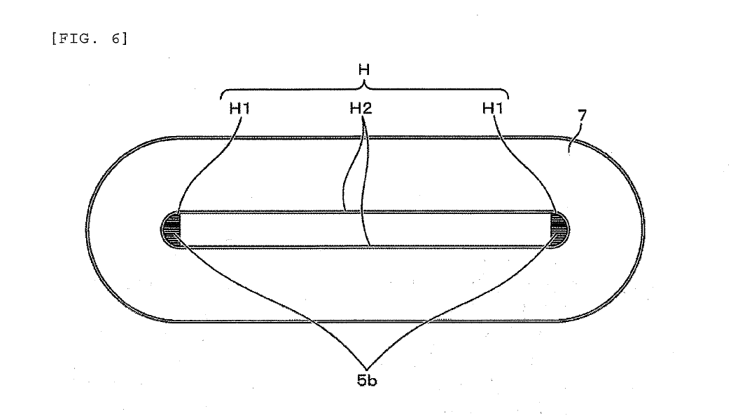

FIG. 5 is a schematic perspective view showing an inner structure of the electrode winding body 7 of the embodiment. As shown in FIG. 5A, the electrode facing part of the electrode winding body 7 is denoted by 7a, and the lead part of the electrode winding body 7 is denoted by 7b.

In the lead part 7b of the electrode winding body 7, the positive electrode lead part 1b and the negative electrode lead part 2b are at opposite positions in a direction perpendicular to the winding direction. In the electrode facing part 7a of the electrode winding body 7, the first separator 3a, the positive electrode lead part 1b, the second separator 4a and the negative electrode lead part 2b are laminated in this order.

FIG. 5B is a view showing the position of the support member 5b in the inside of the electrode winding body 7 and is a view in which a part of the electrode winding body 7 is removed from the perspective view of FIG. 5A. The support member 5b is arranged inside the electrode winding body 7. The side 5b1 of the support member 5b and the side 5b3 (not shown) of the support member 5b are arranged in a form of crossing the inside electrode facing part 7a of the electrode winding body 7, and most of the side 5b1 of the support member 5b and the side 5b3 of the support member 5b contact the insides of the two corner parts of the electrode winding body 7. The side 5b2 (not shown) of the support member 5b and the side 5b4 of the support member 5b exist outside the inside electrode facing part 7a of the electrode winding body 7, and do not contact the inside electrode facing part 7a of the electrode winding body 7. Since the contact does not occur, the electrode facing part 7a of the electrode winding body 7 can expand toward the inside of the electrode winding body 7. That is, clearance for cancelling the expansion of the electrode winding body 7 is provided inside the electrode winding body 7, and the portion near the clearance is positively expanded. By this, the expansion of the battery can be suppressed.

FIG. 6 is a sectional view showing an inner structure of the electrode winding body 7 of the embodiment (corresponding to a B-B sectional view of FIG. 5). In a substantially inner wall H of the electrode winding body 7, when a portion which contacts the support member 5b is made H1, and a portion which does not contact the support member 5b is made H2, as shown in the drawing, the insides of the two corner parts of the electrode winding body 7 are H1, and the inside of the long side is H2. Here, although the size of H2 is not limited, the size is preferably made as large as possible.

### <Integration of Electrode Winding Body and Current Collecting Terminal Part>

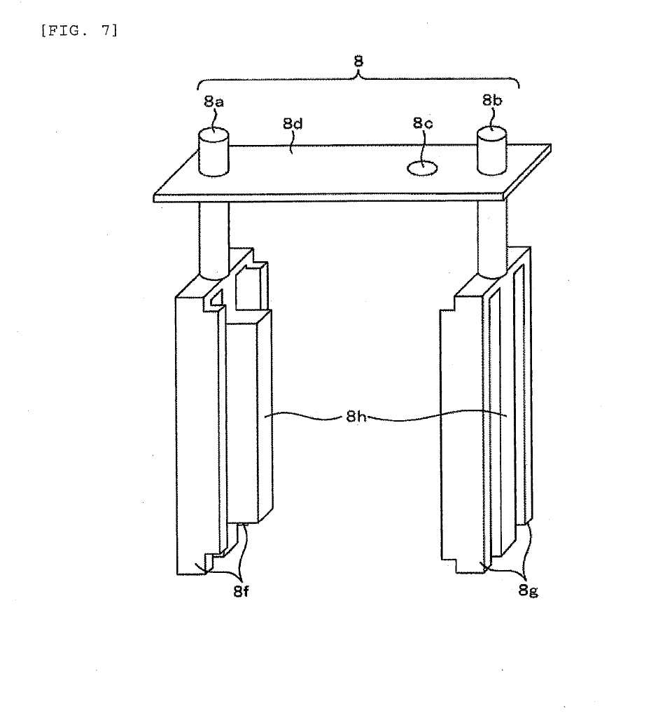

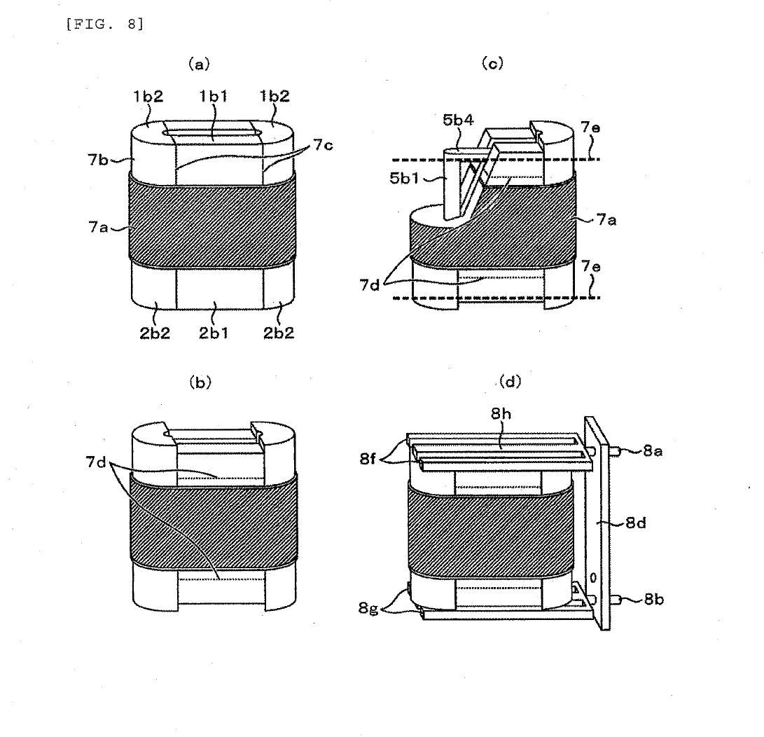

FIG. 7 shows a structure of a current collecting terminal part integrated with the electrode winding body of the embodiment. The current collecting terminal part 8 includes an electrolyte injection port 8c and a plate-like part 8d corresponding to the upper surface of the battery can in addition to a positive electrode current collecting terminal 8a and a negative electrode current collecting terminal 8b. Incidentally, since the plate-like part 8d is made of the same metal material as the battery can, resin material (not shown) is used to insulate between the positive electrode current collecting terminal 8a and the plate-like part 8d and between the negative electrode current collecting terminal 8b and the plate-like part 8d, so that the positive electrode current collecting terminal 8a and the negative electrode current collecting terminal 8b do not electrically contact each other through the plate-like part 8d. Incidentally, this resin material functions also as a gasket. Each of the positive electrode current collecting terminal 8a and the negative electrode current collecting terminal 8b branches into three pillars each having a convex part in the inside of the battery can. Among these pillars, two pillars 8f and 8g at both ends are welded to the lead parts of the electrode winding body. Weld parts of the pillar 8f at the end and the pillar 8g at the end are the convex parts thereof. The positive electrode current collecting terminal 8a and the negative electrode current collecting terminal 8b are exposed to the outside from the inside of the battery can after the battery can is sealed, and charge and discharge of the battery is performed through these. The center pillar 8h has a function to prevent the support member 5b provided inside the electrode winding body 7 from jumping out from the electrode winding body 7. The convex parts of the center pillars 8h hold the side 5b2 of the support member 5b and the side 5b4 of the support member 5b (both are not shown).

First, as shown in FIG. 8A, a cut 7c of the lead part 7b of the electrode winding body 7 was formed in the positive electrode lead part 1b and the negative electrode lead part 2b, and each of the lead parts was divided into a long side part 1b1 of the positive electrode lead part 1b and a long side part 2b1 of the negative electrode lead part 2b, and into a corner part 1b2 of the positive electrode lead part 1b and a corner part 2b2 of the negative electrode lead part 2b. Next, as shown in FIG. 8B, a fold 7d (bent part) of the lead part 7b of the electrode winding body 7 was formed in the long side part 1b1 of the positive electrode lead part 1b and the long side part 2b1 of the negative electrode lead part 2b by pressing.

FIG. 8C is a view showing a position of the support member 5b in the inside of the electrode winding body 7 and is a view in which a part of the electrode winding body 7 is removed from the perspective view of FIG. 8B. The fold 7d of the lead part 7b of the electrode winding body 7 provided in the lead part 7b of the electrode winding body 7, the side 5b2 (not shown) of the support member 5b and the side 5b4 of the support member 5b are positioned between the weld part 7e of the lead part 7b of the electrode winding body 7 and the electrode facing part 7a of the electrode winding body 7.

By the existence of the fold 7d of the lead part 7b of the electrode winding body 7, at the time of liquid injection or the time of charge and discharge, the long side part of the electrode winding body 7 can selectively expand toward the inside gap of the electrode winding body 7. Thus, the expansion and contraction of the electrode layer is facilitated. The fold 7d may be formed between the weld part 7e of the lead part 7b of the electrode winding body 7 and the side 5b4 of the support member 5b and between the side 5b4 of the support member 5b and the electrode facing part 7a of the electrode winding body 7. When the fold 7d is formed between the side 5b4 of the support member 5b and the electrode facing part 7a of the electrode winding body 7, the electrode can be moved more freely.

It is conceivable that one of causes of distortion of the electrode winding body 7 is that when charge and discharge are repeated, the inside of the corner part of the electrode winding body 7 is frayed, and the tension to keep the shape of the long side part of the electrode winding body 7 is reduced. Since the inside of the corner part of the electrode winding body 7 is supported by the support member 5b, fraying of the electrode winding body 7 from the corner part of the electrode winding body 7 is suppressed, and a suitable tension is applied to the long side part of the electrode winding body 7. As a result, the distortion of the electrode winding body 7 is prevented.

Next, as shown in FIG. 8D, the lead part 7b of the electrode winding body 7 and the current collecting terminal part 8 were brought into contact, the lead part 7b of the electrode winding body 7 and the positive electrode current collecting terminal 8a, and the lead part 7b of the electrode winding body 7 and the negative electrode current collecting terminal 8b were integrated by ultrasonic welding, so that the integrated unit of the electrode winding body and the current collecting terminal part was obtained.

Incidentally, in the electrode winding body of the embodiment of the invention, it is desirable that the fold 7d is not provided in all the lead parts. As an undesirable way of providing the fold, for example, a shape rounding the lead part is conceivable. If the fold is provided for all the lead parts, the shape of the electrode winding body is unstable. Besides, only the long side part of the electrode winding body can not be selectively expanded or contracted. Thus, it is desirable that the bent part is not provided for only the lead part 7b at the outermost periphery of the electrode winding body 7.

### <Fabrication of Square Secondary Battery>

The integrated unit of the electrode winding body and the current collecting terminal part was contained in an insulating case, and then was inserted in the battery can. Next, the plate-like part of the integrated unit of the electrode winding body and the current collecting terminal part and the battery can were integrated by laser welding. After an electrolyte (prepared by dissolving LiPF₆ in solution of ethylene carbonate (EC): ethylene methyl carbonate (EMC))=1:3 so as to have a concentration of 1 mol/L) was injected through the electrolyte injection port of the plate-like part, a metal cap was put on the electrolyte injection port. The metal cap and the plate-like part were integrated by laser welding to seal the electrolyte injection port, and the square secondary battery of the invention was obtained.

Here, as the electrolyte of the invention, diethyl carbonate (DEC), dimethyl carbonate (DMC), propylene carbonate (PC) or the like can be used in addition to EC and EMC.

As a lithium salt of supporting electrolyte of the invention, LiBF₄, LiCF₃SO₃ or the like can be used in addition to LiPF₆. The concentration of the lithium salt is required to be adjusted to an optimum concentration because the characteristics are deteriorated if the concentration is excessively high or excessively low. Empirically, about 0.8 mol/L to 1.2 mol/L is preferable.

Besides, from the viewpoint of improvement of storage life characteristics and improvement of heat resistance, various additives may be added to the electrolyte. In that case, vinylene carbonate (VC), fluoroethylene carbonate (FEC), phosphoric acid ester containing alkyl fluoride group, carbonic acid ester or the like can be used.

When the invention is applied, in addition to the square secondary battery, a wound type laminated secondary battery may be adopted.

The usage of the secondary battery of the invention is not particularly limited. For example, the secondary battery can be used as a power source for a portable information communication equipment such as a personal computer, a word processor, a cordless telephone handset, an electronic book player, a cellular phone, a car phone, a handy terminal, transceiver or a portable radio machine. Besides, the secondary battery can be used as a power source for various portable equipment such as a portable copying machine, an electronic notebook, an electric calculator, a liquid crystal television, a radio, a tape recorder, a headphone stereo, a portable CD player, a video movie, an electric shaver, an electronic translating machine, a voice input equipment or a memory card. In addition, the secondary battery can be used as a power source for a household electrical equipment such as a refrigerator, an air conditioner, a television, a stereo, a water heater, a microwave oven, a dishwasher, a dryer, a washing machine, a lighting equipment or a toy. Besides, the secondary battery can be used as a battery for an electric tool or a nursing tool (electric wheelchair, electric bed, electric bathing equipment, etc.) irrespective of home use or business use. Further, the invention can be applied as a power source for a medical equipment, a construction machine, a power storage system, an elevator, an unmanned moving vehicle or the like for industrial use, and can be further applied as a power source for a moving body such as an electric vehicle, a hybrid electric vehicle, a plug-in hybrid electric vehicle, a golf cart or a turret vehicle. Further, the invention can be used as a power storage system usable in a place other than a ground, such as a space station, a space ship or a shape base, in which electric power generated by a solar cell or a fuel cell is charged to the battery module of the invention.

### REFERENCE SIGNS LIST

1 positive electrode sheet
1a positive electrode layer
1b positive electrode lead part
1b1 long side part of positive electrode lead part
1b2 corner part of positive electrode lead part
1c positive electrode roll
2 negative electrode sheet
2a negative electrode layer
2b negative electrode lead part
2b1 long side part of negative electrode lead part
2b2 corner part of negative electrode lead part
2c negative electrode roll
3, 4 separator roll
3a first separator
4a second separator
5 winding unit
5a axial core
5a1 plate part
5a2 insertion part
5b support member
5b1, 5b2, 5b3, 5b4 side of support member
5c1 concave part
5c2 convex part
5d fastening part
6 adhesive tape
7, a electrode winding body
7a electrode facing part of electrode winding body
7b lead part of electrode winding body
7c cut of lead part of electrode winding body
7d fold of lead part of electrode winding body
7e weld part of lead part of electrode winding body
8 current collecting terminal part
8a positive electrode current collecting terminal
8b negative electrode current collecting terminal
8c electrolyte injection port
8d plate-like part
8f, 8g pillar at end
8h center pillar
A wall surface of can of square battery
A1, A3 wide width surface of can of square battery
A2, A4 narrow width surface of can of square battery
a1, a2, a3, a4 area of electrode winding body
H substantially inner wall of electrode winding body
H1 portion in contact with support member
H2 portion not in contact with support member
L line indicating substantially inner wall in section of electrode winding body

1. A non-aqueous electrolyte wound type secondary battery comprising:
an electrode winding body including a positive electrode sheet, a negative electrode sheet and a separator formed between the positive electrode sheet and the negative electrode sheet;
a support member which is formed inside the electrode winding body and around which the electrode winding body is wound; and
a battery can which contains the electrode winding body and the support member, wherein
the positive electrode sheet includes a positive electrode layer and a positive electrode lead part,
the negative electrode sheet includes a negative electrode layer and a negative electrode lead part,
an inside of a corner part of the electrode winding body is supported by the support member,
a gap is provided inside the lead part of the electrode winding body and inside the support member,
in the lead part of the electrode winding body, the positive electrode lead part or the negative electrode lead part includes a bent part, and
the bent part is formed between a side of the support member in a direction perpendicular to a winding axis direction of the electrode winding body and an electrode facing part of the electrode winding body.

2. The non-aqueous electrolyte wound type secondary battery according to claim 1, wherein the support member has a rectangular tubular shape.

3. The non-aqueous electrolyte wound type secondary battery according to claim 1, wherein a section of the support member has a dumbbell shape.

4. The non-aqueous electrolyte wound type secondary battery according to claim 1, wherein
a side of the support member in the winding axis direction of the electrode winding body contacts the electrode facing part of the electrode winding body, and
the side of the support member in a direction perpendicular to the winding axis direction of the electrode winding body does not contact the electrode facing part of the electrode winding body.

5. The non-aqueous electrolyte wound type secondary battery according to claim 1, wherein
the non-aqueous electrolyte wound type secondary battery includes a positive electrode current collecting terminal and a negative electrode current collecting terminal,
the positive electrode current collecting terminal and the negative electrode current collecting terminal are provided with convex parts, and
the convex part of the positive electrode current collecting terminal and the convex part of the negative electrode current collecting terminal hold the support member.

6. (canceled)

7. (canceled)

8. The non-aqueous electrolyte secondary battery according to claim 1, wherein the bent part is not formed only in the positive electrode lead part or the negative electrode lead part at an outermost periphery in the electrode winding body.

9. The non-aqueous electrolyte secondary battery according to claim 1, wherein a shape of the battery can is square.
